(19) United States
(12) Patent Application Publication
(10) Pub. No.: US 2013/0181676 A1
(43) Pub. Date: Jul. 18, 2013

(54) COMPOSITIONS, ELECTRODES AND METHODS OF MAKING

(71) Applicant: E I DU PONT DE NEMOURS AND COMPANY, Wilmington, DE (US)

(72) Inventors: Kostantinos Kourtakis, Media, PA (US); David Richard Corbin, West Chester, PA (US)

(73) Assignee: E I DU PONT DE NEMOURS AND COMPANY, Wilmington, DE (US)

(21) Appl. No.: 13/743,692

(22) Filed: Jan. 17, 2013

Related U.S. Application Data
(60) Provisional application No. 61/587,805, filed on Jan. 18, 2012.

(51) Int. Cl. H01M 4/133; H01M 10/44

(52) U.S. Cl. CPC H01M 4/133; H01M 10/44
USPC 320/128; 429/217; 429/211; 427/113

(57) ABSTRACT

There is a composition including polymeric binder and carbon-sulfur (C—S) composite. The C—S composite includes about 5 to 95 wt. % sulfur compound. The C—S composite also includes templated carbon having a surface area of about 50 to 4,000 square meters per gram templated carbon and a pore volume of about 0.5 to 6 cubic centimeters per gram templated carbon. The templated carbon has a carbon microstructure that is complementary with an inorganic microstructure, characterized by a three-dimensional framework, of an inorganic template used in a process for making the templated carbon. There is a method for making the composition. There is also an electrode incorporating the composition, as well as methods for making the electrode. There are also methods relating to using the composition and the electrode.

### CROSS-REFERENCE TO RELATED APPLICATIONS

This application claims priority to and the benefit of the filing date of U.S. Provisional Application Nos. 61/587,805, filed on Jan. 18, 2012, the entirety of which is herein incorporated by reference.

### BACKGROUND OF THE INVENTION

There is significant interest in lithium sulfur (i.e., “Li—S”) batteries as potential portable power sources for their applicability in different areas. These areas include emerging areas, such as electrically powered automobiles and portable electronic devices, and traditional areas, such as car ignition batteries. Li—S batteries offer great promise in terms of cost, safety and capacity, especially compared with lithium ion battery technologies not based on sulfur. For example, elemental sulfur is often used as a source of electroactive sulfur in a Li—S cell of a Li—S battery. The theoretical charge capacity associated with electroactive sulfur in a Li—S cell based on elemental sulfur is about 1,672 mAh/g S. In comparison, a theoretical charge capacity in a lithium ion battery based on a metal oxide is often less than 250 mAh/g metal oxide. For example, the theoretical charge capacity in a lithium ion battery based on the metal oxide species LiFePO₄ is 176 mAh/g.

A Li—S battery includes one or more electrochemical voltaic Li—S cells which derive electrical energy from chemical reactions occurring in the cells. A cell includes at least one positive electrode. When a new positive electrode is initially incorporated into a Li—S cell, the electrode includes an amount of sulfur compound incorporated within its structure. The sulfur compound includes potentially electroactive sulfur which can be utilized in operating the cell. A negative electrode in a Li—S cell commonly includes lithium metal. In general, the cell includes a cell solution with one or more solvents and electrolytes. The cell also includes one or more porous separators for separating and electrically isolating the positive electrode from the negative electrode, but permitting diffusion to occur between them in the cell solution. Generally, the positive electrode is coupled to at least one negative electrode in the same cell. The coupling is commonly through a conductive metallic circuit.

Li—S cell configurations also include, but are not limited to, those having a negative electrode which initially does not include lithium metal, but includes another material. Examples of these materials are graphite, silicon-alloy and other metal alloys. Other Li—S cell configurations include those with a positive electrode incorporating a lithiated sulfur compound, such as lithium sulfide (i.e., “Li₂S”).

The sulfur chemistry in a Li—S cell involves a related series of sulfur compounds. During a discharge phase in a Li—S cell, lithium is oxidized to form lithium ions. At the same time larger or longer chain sulfur compounds in the cell, such as S₈ and Li₂S₈, are electrochemically reduced and converted to smaller or shorter chain sulfur compounds. In general, the reactions occurring during discharge may be represented by the following theoretical discharging sequence of the electrochemical reduction of elemental sulfur to form lithium polysulfides and lithium sulfide:

S₈→Li₂S₈→Li₂S₆→Li₂S₄→Li₂S₃→Li₂S₂→Li₂S

During a charge phase in a Li—S cell, a reverse process occurs. The lithium ions are drawn out of the cell solution. These ions may be plated out of the solution and back to a metallic lithium negative electrode. The reactions may be represented, generally, by the following theoretical charging sequence representing the electrooxidation of the various sulfides to elemental sulfur:

Li₂S→Li₂S₂→Li₂S₃→Li₂S₄→Li₂S₆→Li₂S₈→S₈

A common limitation of previously-developed Li—S cells and batteries is capacity degradation or capacity “fade”. It is generally believed that capacity fade is due, in part, to sulfur loss through the formation of certain soluble sulfur compounds which “shuttle” between electrodes in a Li—S cell and react to deposit on a surface of a negative electrode forming “anode-deposited” sulfur compounds. It is believed that the anode-deposited sulfur compounds can obstruct and otherwise foul the surface of the negative electrode and may also result in sulfur loss from the total electroactive sulfur in the cell. The formation of anode-deposited sulfur compounds involves complex chemistry which is not completely understood.

Some previously-developed Li—S cells and batteries have utilized high loadings of sulfur compound in their positive electrodes in attempting to address the drawbacks associated with capacity degradation and anode-deposited sulfur compounds. However, simply utilizing a high loading of sulfur compound presents other difficulties, including a lack of adequate containment for the entire amount of sulfur compound in the high loading. Furthermore, the positive electrodes made with these compositions tend to crack or break. Another difficulty might be due, in part, to the insulating effect of the high loading of sulfur compound. This insulating effect may contribute to difficulties in realizing the full capacity associated with all the potentially electroactive sulfur in the high loading in a positive electrode of these previously-developed Li—S cell and batteries.

Conventionally, the lack of adequate containment for a high loading of sulfur compound has been addressed by incorporating a high amount of binder in the positive electrodes of these previously-developed Li—S cell and batteries. However, a positive electrode incorporating a high binder amount tends to have a lower sulfur utilization which, in turn, lowers the effective maximum discharge capacity of the Li—S cells with these electrodes.

Li—S cells and batteries are desirable based on the high theoretical capacities and high theoretical energy densities of the electroactive sulfur in their positive electrodes. However, attaining the full theoretical capacities and energy densities remains elusive. In addition, the concomitant limitations associated with capacity degradation, anode-deposited sulfur compounds and the poor conductivities intrinsic to sulfur compound itself, all of which are associated with previously-developed Li—S cells and batteries, limits the application and commercial acceptance of Li—S batteries as power sources.

Given the foregoing, what is needed are Li—S cells and batteries without the above-identified limitations of previously-developed Li—S cells and batteries.

### BRIEF SUMMARY OF THE INVENTION

This summary is provided to introduce a selection of concepts. These concepts are further described below in the Detailed Description. This summary is not intended to identify key features or essential features of the claimed subject matter. Also, this summary is not intended as an aid in determining the scope of the claimed subject matter.

The present invention meets the above-identified needs by providing a carbon-sulfur (i.e., “C—S”) composite containing “templated” carbon and sulfur compound. The templated carbon is a porous material with a carbon microstructure which, according to an embodiment, is complementary to an inorganic microstructure of an inorganic template utilized in making the templated carbon. The inorganic template may be an aluminosilicate molecular sieve, such as a zeolite, with an inorganic microstructure having select aspects relating to its physical structure. In an embodiment, the select aspects relating to the physical structure of the inorganic template are reflected in the carbon microstructure of the templated carbon.

The sulfur compound of the C—S composite is located substantially within the carbon microstructure of the templated carbon. According to different embodiments, different species of sulfur compound may be utilized. Also, different amounts of sulfur compound, such as percentages by weight C—S composite, may be utilized. The C—S composite may be a component of a composition which comprises polymeric binder, optionally with other components. The composition can be incorporated into positive electrodes of Li—S cells. Examples of C—S composites with different templated carbon materials, based on various inorganic templates as well as compositions with the C—S composites incorporated into positive electrodes, according to different embodiments, are described below in the Detailed Description.

Positive electrodes incorporating a composition comprising C—S composite with templated carbon, according to the principles of the invention, provide Li—S cells and batteries with high maximum discharge capacities, and without the above-identified limitations of previously-developed Li—S cells and batteries. While not being bound by any particular theory, it is believed that Li—S cells with the templated carbon in C—S composites in compositions incorporated into the positive electrodes, according to the principles of the invention, provide a high maximum discharge capacity in a Li—S battery. In addition, the Li—S cells do not demonstrate low sulfur utilization or high discharge capacity degradation.

These and other objects are accomplished by the compositions, electrodes, methods for making such and methods for using such, in accordance with the principles of the invention.

According to a first principle of the invention, there is a composition which may comprise about 1 to 17.5 wt. % polymeric binder and about 50 to 99 wt. % C—S composite. The C—S composite may comprise about 5 to 95 wt. % sulfur compound. The templated carbon may have a surface area of about 50 to 4,000 square meters per gram templated carbon and/or it may have a pore volume of about 0.5 to 6 cubic centimeters per gram templated carbon. The templated carbon may have a carbon microstructure that is complementary with an inorganic microstructure, characterized by a three-dimensional framework, of an inorganic template used in a process for making the templated carbon. The inorganic template may have a framework density of about 10 to 25, or about 11 to 21, or about 12 to 17. The three dimensional framework may have a wall thickness and/or average wall thickness of less than about 30 angstroms, or less than about 20 angstroms, or less than about 15 angstroms. The three-dimensional framework may comprise rings having about 4 to 30 tetrahedrally coordinated atoms, or about 4 to 20 tetrahedrally coordinated atoms, or about 4 to 18 tetrahedrally coordinated atoms, or about 4 to 16 tetrahedrally coordinated atoms, or about 4 to 14 tetrahedrally coordinated atoms, or about 4 to 12 tetrahedrally coordinated atoms, or about 4 to 10 tetrahedrally coordinated atoms, or about 4 to 8 tetrahedrally coordinated atoms or about 4 to 6 tetrahedrally coordinated atoms. The rings may have a dimension in a pore diameter of about 0.5 to 5 nanometers or about 0.6 to 5 nanometers. The inorganic template may be siliceous and/or aluminosiliceous. The inorganic template may be one of ZSM-5, silicalite (MFI), ZSM-11 (MEL), ZSM-22 (TON) and ZSM-48 (MRE), or one of zeolite beta (BEA), faujasite (FAU), mordenite (MOR), zeolite-L (LTL), NaX (FAU), NaY (FAU), DA-Y (FAU) and CaY (FAU), or one of AIPO-8, CIT-5, Cloverite, UTD-1F, ECR-34, ITQ-44, ITQ-37, OSB-1, SSZ-53, SSZ-59, IM-12 and VPI-5, or one of H-beta, 13-X, Mordenite, Omega-5, Silicalite and Na—Y. The composition may further comprise about 1 to 15 wt. % carbon black. The composition may comprise about 2 to 8 wt. % polymeric binder, and/or about 70 to 90 wt. % C—S composite, and/or about 5 to 10 wt. % carbon black. The C—S composite in the composition may comprise about 50 to 85 wt. % sulfur compound. The C—S composite in the composition may be prepared utilizing a process for making the C—S composite comprising introducing a carbon precursor into an inorganic template, and/or stabilizing carbon from the introduced carbon precursor to form a stabilized carbon in proximity with the inorganic template, and/or removing the inorganic template from the stabilized carbon to form a templated carbon, and/or introducing a sulfur compound into the templated carbon to form the C—S composite. The process for making the C—S composite may comprise introducing a second carbon precursor supplementing the stabilized carbon. The process for making the C—S composite may comprise heating the sulfur compound to at least about 100° C. The process for making the C—S composite may comprise heating the sulfur compound to about 160° C. and directly contacting the heated sulfur compound with the templated carbon. The process for making the C—S composite may comprise heating the sulfur compound to at least about 250° C. The process for making the C—S composite may comprise stabilizing which includes heating the introduced carbon precursor. The process for making the C—S composite may comprise stabilizing which includes wherein the stabilizing includes polymerizing the introduced carbon precursor. The inorganic template may have a molecular crystallographic structure including at least one of AlO₄ and SiO₄. The inorganic template may have a molecular crystallographic structure characterized by the formula: M_{2/n}O.Al₂O₃.xSiO₂.yH₂O in which M is a cation of valence n, x is greater than or equal to about 2, and y is a number associated with a pore volume and a hydration state of the inorganic template.

According to a second principle of the invention, there is a method for making a composition. The method may comprise introducing a carbon precursor into an inorganic template, and/or stabilizing carbon from the introduced carbon precursor to form a stabilized carbon in proximity with the inorganic template, and/or removing the inorganic template from the stabilized carbon to form a templated carbon. The templated carbon may have a surface area of about 50 to 4,000 square meters per gram templated carbon and/or it may have a pore volume of about 0.5 to 6 cubic centimeters per gram templated carbon. The templated carbon may have a carbon microstructure that is complementary with an inorganic microstructure, characterized by a three-dimensional framework, of an inorganic template used in a process for making the templated carbon. The method may also comprise introducing an amount of sulfur compound into the templated carbon to form a C—S composite comprising about 5 to 95 wt. % sulfur compound. The method may also comprise introducing a second carbon precursor to supplement the stabilized carbon. The method may also comprise heating the sulfur compound to at least about 250° C. The method may also comprise heating the sulfur compound to about 160° C. and directly contacting the heated sulfur compound with the templated carbon. The method may also comprise combining polymeric binder to make a composition comprising about 1 to 17.5 weight % polymeric binder, and/or introducing an amount of sulfur to make a C—S composite with about 50 to 99 weight % C—S composite in the composition. The method may also comprise combining an amount of sulfur to make a C—S composite with about 10 to 88 wt. % sulfur compound in the composition. The method may also comprise combining an amount of sulfur to make a C—S composite with about 50 to 85 wt. % sulfur compound in the composition.

According to a third principle of the invention, there is an electrode comprising a circuit contact and a composition. The composition may comprise about 1 to 17.5 wt. % polymeric binder and about 50 to 99 wt. % C—S composite. The C—S composite may comprise about 5 to 95 wt. % sulfur compound. The templated carbon may have a surface area of about 50 to 4,000 square meters per gram templated carbon and/or it may have a pore volume of about 0.5 to 6 cubic centimeters per gram templated carbon. The templated carbon may have a carbon microstructure that is complementary with an inorganic microstructure, characterized by a three-dimensional framework, of an inorganic template used in a process for making the templated carbon. The inorganic template may have a framework density of about 10 to 25, or about 11 to 21, or about 12 to 17. The three dimensional framework may have a wall thickness and/or average wall thickness of less than about 30 angstroms, or less than about 20 angstroms, or less than about 15 angstroms. The three-dimensional framework may comprise rings having about 4 to 30 tetrahedrally coordinated atoms, or about 4 to 20 tetrahedrally coordinated atoms, or about 4 to 18 tetrahedrally coordinated atoms, or about 4 to 16 tetrahedrally coordinated atoms, or about 4 to 14 tetrahedrally coordinated atoms, or about 4 to 12 tetrahedrally coordinated atoms, or about 4 to 10 tetrahedrally coordinated atoms, or about 4 to 8 tetrahedrally coordinated atoms or about 4 to 6 tetrahedrally coordinated atoms. The rings may have a dimension in a pore diameter of about 0.5 to 5 nanometers or about 0.6 to 5 nanometers. The inorganic template may be siliceous and/or aluminosiliceous. The inorganic template may be one of ZSM-5, silicalite (MFI), ZSM-11 (MEL), ZSM-22 (TON) and ZSM-48 (MRE), or one of zeolite beta (BEA), faujasite (FAU), mordenite (MOR), zeolite-L (LTL), NaX (FAU), NaY (FAU), DA-Y (FAU) and CaY (FAU), or one of AIPO-8, CIT-5, Cloverite, UTD-1F, ECR-34, ITQ-44, ITQ-37, OSB-1, SSZ-53, SSZ-59, IM-12 and VPI-5, or one of H-beta, 13-X, Mordenite, Omega-5, Silicalite and Na—Y.

According to a first principle of the invention, there is a method for using a cell. The method comprising a step of converting chemical energy stored in the cell into electrical energy, and/or a step of converting electrical energy into chemical energy stored in the cell. The cell may comprise a negative electrode, and/or a positive electrode including a sulfur compound, and/or a circuit coupling the positive electrode and negative electrode, and/or a lithium-containing electrolyte medium. The positive electrode may incorporate a composition. The composition may comprise about 1 to 17.5 wt. % polymeric binder and about 50 to 99 wt. % C—S composite. The C—S composite may comprise about 5 to 95 wt. % sulfur compound. The templated carbon may have a surface area of about 50 to 4,000 square meters per gram templated carbon and/or it may have a pore volume of about 0.5 to 6 cubic centimeters per gram templated carbon. The templated carbon may have a carbon microstructure that is complementary with an inorganic microstructure, characterized by a three-dimensional framework, of an inorganic template used in a process for making the templated carbon. The cell may be associated with a portable battery, and/or a power source for an electrified vehicle, and/or a power source for an ignition system of a vehicle and/or a power source for a mobile device.

The above summary is not intended to describe each embodiment or every implementation of the present invention. Further features, their nature and various advantages will be more apparent from the accompanying drawings and the following detailed description of the examples and embodiments.

### BRIEF DESCRIPTION OF THE DRAWINGS

The features and advantages of the present invention become more apparent from the detailed description set forth below when taken in conjunction with the drawings in which like reference numbers indicate identical or functionally similar elements. Additionally, the left-most digit of a reference number identifies the drawing in which the reference number first appears.

In addition, it should be understood that the drawings in the figures, which highlight the aspects, methodology, functionality and advantages of the present invention, are presented for example purposes only. The present invention is sufficiently flexible, such that it may be implemented in ways other than shown in the accompanying figures.

FIG. 1 is a two dimensional perspective of a Li—S cell with a positive electrode comprising a composition including C—S composite with templated carbon, according to an example;

FIG. 2 is a context diagram illustrating properties of a Li—S battery including a Li—S cell with a positive electrode comprising a composition including C—S composite with templated carbon, according to an example;

FIG. 3 is a two dimensional perspective of a Li—S coin cell with a positive electrode comprising a composition including C—S composite with templated carbon, according to an example;

FIG. 4 is a chart depicting electrochemical measurements of Li—S coin cells with a positive electrode comprising a composition including C—S composite with templated carbon, according to specific examples described below; and

FIG. 5 is a graph depicting electrochemical measurements of the maximum discharge capacity of a Li—S coin cell with a positive electrode comprising a composition including C—S composite with templated carbon, according to an example, in a run of charge-discharge cycles.

### DETAILED DESCRIPTION

The present invention is useful for certain energy storage applications, and has been found to be particularly advantageous for high maximum discharge capacity batteries utilizing electrochemical voltaic cells which derive electrical energy from chemical reactions involving sulfur compounds. While the present invention is not necessarily limited to such applications, various aspects of the invention are appreciated through a discussion of various examples using this context.

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from a series of examples, as described below. The embodiments on which these examples are based are representative only. The selection of those embodiments to illustrate the principles of the invention does not indicate that materials, components, reactants, conditions, techniques, configurations and designs, etc. which are not described in the examples are not suitable for use, or that subject matter not described in the examples is excluded from the scope of the appended claims and their equivalents. The significance of the examples can be better understood by comparing the results obtained therefrom with potential results which can be obtained from tests or trials that may be or may have been designed to serve as controlled experiments and provide a basis for comparison.

As used herein, the terms “based on”, “comprises”, “comprising”, “includes”, “including”,” “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This is done merely for convenience and to give a general sense of the description. This description should be read to include one or at least one and the singular also includes the plural unless it is obvious that it is meant otherwise.

As used herein and unless otherwise stated the term “cathode” is used to identify a positive electrode and “anode” to identify the negative electrode of a battery or cell. The term “battery” is used to denote a collection of one or more cells arranged to provide electrical energy. The cells of a battery can be arranged in various configurations (e.g., series, parallel and combinations thereof).

The term “sulfur compound” as used herein refers to any compound that includes at least one sulfur atom, such as elemental sulfur and other sulfur compounds, such as lithiated sulfur compounds including disulfide compounds and polysulfide compounds. For further details on examples of sulfur compounds particularly suited for lithium batteries, reference is made to “A New Entergy Storage Material: Organosulfur Compounds Based on Multiple Sulfur-Sulfur Bonds”, by Naoi et al, J. Electrochem. Soc., Vol. 144, No. 6, pp. L170-L172 (June 1997), which is incorporated herein by reference in its entirety.

The meaning of abbreviations and certain terms used herein is as follows: “A” means angstrom(s), “g” means gram(s), “mg” means milligram(s), “μg” means microgram(s), “L” means liter(s), “mL” means milliliter(s), “cc” means cubic centimeter(s), “cc/g” means cubic centimeters per gram, “mol” means mole(s), “mmol” means millimole(s), “M” means molar concentration, “wt. %” means percent by weight, “Hz” means hertz, “mS” means millisiemen(s), “mA” mean milliamp(s), “mAh/g” mean milliamp hour(s) per gram, “mAh/g S” mean milliamp hour(s) per gram sulfur based on the weight of sulfur atoms in a sulfur compound, “V” means volt(s), “x C” refers to a constant current that may fully charge/discharge an electrode in 1/x hours, “SOC” means state of charge, “SEI” means solid electrolyte interface formed on the surface of an electrode material, “kPa” means kilopascal(s), “rpm” means revolutions per minute, “psi” means pounds per square inch, “maximum discharge capacity” is the maximum milliamp hour(s) per gram of a positive electrode in a Li—S cell at the beginning of a discharge phase, “coulombic efficiency” is the fraction or percentage of the electrical charge stored in a rechargeable battery by charging and is recoverable during discharging and is expressed as 100 times the ratio of the charge capacity on discharge to the charge capacity on charging, “pore volume” (i.e., “Vp”) is the sum of the volumes of all the pores in one gram of a substance and may be expressed as cc/g, “porosity” (i.e., “void fraction”) is either the fraction (0-1) or the percentage (0-100%) expressed by the ratio: (volume of voids in a substance)/(total volume of the substance).

According to the principles of the invention, as demonstrated in the following examples and embodiments, there are compositions, electrodes, associated methods for making such and associated methods for using such. The composition comprises C—S composite including templated carbon having sulfur compound situated within porous regions of a carbon microstructure in the templated carbon. According to an embodiment, the C—S composite may be combined with polymeric binder in the composition. In another embodiment, the composition may comprise conductive carbon black.

The C—S composite may comprise a percentage by weight of sulfur compound in the C—S composite (i.e., “sulfur compound loading”) that is greater than zero. In an embodiment, the percentage may vary from about 5 to 95 wt. % of the C—S composite. In another embodiment, the percentage may vary from about 10 to 88 wt. %. In yet another embodiment, the percentage may vary from about 50 to 85 wt. %. Other sulfur compound loadings may be utilized as described in greater detail below. Various processes, including compositing and other processes, may be utilized to situate the sulfur compound within the porous regions of a carbon microstructure in the templated carbon to make the C—S composite. These processes for making are described in greater detail below.

As demonstrated in the following examples and embodiments, the C—S composite includes templated carbon. The templated carbon has a carbon microstructure which may be substantially complementary to an inorganic microstructure of an inorganic template, such as an aluminosilicate molecular sieve (e.g., a zeolite). The inorganic microstructure of the inorganic template may reflect select aspects relating to the physical structure of the inorganic template. A complement of the inorganic microstructure may be reflected in the carbon microstructure of the templated carbon in the C—S composite.

In addition, there are methods for making compositions comprising the C—S composite, and for making positive electrodes incorporating the compositions. The composition may be made through various processes which combine components in the composition. According to an embodiment, the components may simply be combined to form a composition which may then be incorporated into an electrode structure.

A positive electrode incorporating a composition, according to the principles of the invention, in a cell of a Li—S battery, is associated with high maximum discharge capacity and high sulfur utilization properties of the battery. The maximum discharge capacity and sulfur utilization properties associated with positive electrodes comprising compositions, according to the principles of the invention, are surprisingly high. Without being bound by any particular theory, the high maximum discharge capacities observed on discharge in positive electrodes, according to the principles of the invention, appears to be a direct consequence of incorporating compositions comprising C—S composite including templated carbon in the positive electrodes.

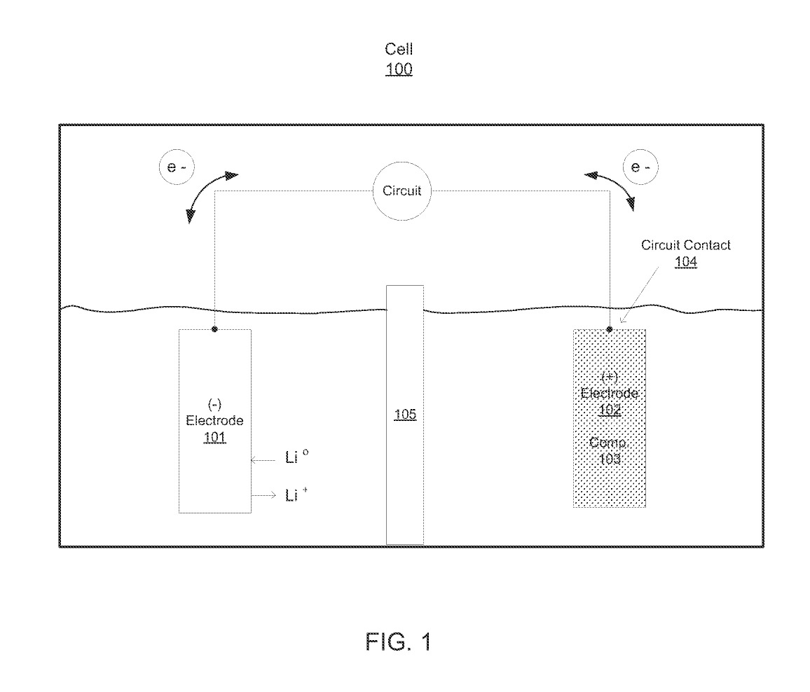

Referring to FIG. 1, depicted is a cell 100 in a Li—S battery, comprising a positive electrode 102 incorporating a composition 103. The composition 103 comprises a C—S composite comprising sulfur compound and templated carbon, according to the principles of the invention. The cell 100 includes a lithium containing negative electrode 101 and a porous separator 105. The positive electrode 102 includes a circuit contact 104. The circuit contact 104 provides a conductive conduit for the positive electrode 102 to a circuit. The positive electrode 102 is operable in conjunction with a negative electrode, such as the lithium-containing negative electrode 101. The templated carbon of the C—S composite in composition 103 has a carbon microstructure which is complementary to an inorganic microstructure of an inorganic template used in making the templated carbon. The inorganic microstructure has select aspects relating to the physical structure of the inorganic template. A complement of the inorganic microstructure is reflected in the carbon microstructure of the templated carbon of the C—S composite in the composition 103. Sulfur compound, such as elemental sulfur, lithium sulfide and combinations of such, is incorporated into the C—S composite so as to be located in the porous regions within the carbon microstructure of the templated carbon in the C—S composite. The composition 103 comprises the C—S composite with polymeric binder, and optionally with carbon black and other components.

The carbon microstructure of the templated carbon may be characterized by structural aspects describing the templated carbon, such as a pore volume, a porosity, a three dimensional framework, a wall thickness of the three dimensional framework, an average wall thickness of the three dimensional framework, a pore diameter, an average pore diameter, etc. The structural aspects characterizing the carbon microstructure of the templated carbon are determined, in part, as complementary with structural aspects of an inorganic microstructure of an inorganic template utilized in making the templated carbon. The inorganic microstructure of the inorganic template may be characterized by structural aspects describing the inorganic template, such as a pore volume, a porosity, a three dimensional framework, a wall thickness of the three dimensional framework, an average wall thickness of the three dimensional framework, a pore diameter, an average pore diameter, etc. The templated carbon may be prepared by various processes in which the carbon microstructure of the templated carbon is formed utilizing the inorganic template, as described in greater detail or demonstrated by way of various examples below.

The carbon microstructure of a templated carbon may be formed utilizing a carbon precursor. A carbon precursor is any carbon-containing compound or carbonaceous substance which may introduce carbon into porous regions within an inorganic template. A carbon precursor may be polymerizable monomers, oligomers and polymers. A carbon precursor may also be non-polymerizable. A carbon precursor may be in the form of a gas, a liquid, or a gel. A carbon precursor may also be a solid which has been solvated, dissolved, solubilized, liquefied, melted and/or vaporized to form a fluid which can be introduced into an inorganic microstructure of an inorganic template.

In an embodiment, a templated carbon is formed by introducing carbon precursor into porous regions of the inorganic microstructure within an inorganic template, such as a zeolite. With the carbon precursor impregnating the inorganic template, the impregnated mass is treated to stabilize the carbon of the carbon precursor within the impregnated porous regions of the inorganic template. As the carbon precursor is stabilized, the stabilized carbon is conformed to the inorganic microstructure within the inorganic template. Stabilization may be accomplished through many well-known means including heat, light, chemical treatment, sound, etc. such that the carbon of the carbon precursor is made substantially inert. The stabilization is such that the stabilized carbon is substantially inert to a subsequent removal of the inorganic template from the stabilized mass including the stabilized carbon which had impregnated the inorganic template. After the inorganic template is removed, the remainder is a templated carbon having a carbon microstructure that is complementary, either fully, substantially or in part, with the inorganic microstructure of the inorganic template which has been removed. For example, if an inorganic template used to make a templated carbon has an inorganic microstructure with a larger average pore diameter, a larger pore volume and/or a smaller average wall thickness in the walls of its three dimensional framework, a templated carbon formed utilizing the inorganic template tends to have complementary features, such as a smaller average pore diameter, a smaller pore volume and/or a larger average wall thickness in its carbon microstructure.

According to an example, a polymerizable carbon precursor, such as an alcohol, may be reacted to form polymerized carbon within an inorganic template, such as a zeolite. The polymerizing reaction may be driven, such as by heating, adding a catalyst and/or other conditions may be applied which may utilize energy to drive the polymerization. Such methods are well-known to those of ordinary skill in the art for polymerizing a carbon precursor. The zeolitic inorganic template may then be removed from the polymerized carbon by treating the carbon/zeolite mass to remove the zeolite. According to an example, the polymerized carbon may first be treated, such as by calcining the combined carbon/zeolite mass to decompose the polymerized carbon into a more stable carbon material before applying a treatment, such as by washing with an acid or base, to remove the zeolite. A carbon microstructure formed from polymerized carbon may be better preserved and/or a carbon microstructure may be formed that is more complementary to part or all of the inorganic microstructure of the zeolitic inorganic template utilized, by forming the templated carbon from an alcohol carbon precursor. Once an inorganic template is removed, the remainder, such as a polymerized carbon or a calcined carbon material, is a templated carbon according to the examples described above.

The templated carbon may be described as a carbon molecular sieve. Carbon molecular sieves are associated with one of two general classes of materials which are both categorized in the art as carbon molecular sieves, but are substantially different. The first category of carbon molecular sieve materials is associated with templated carbon, according to the principles of the invention. This category includes carbon materials which are produced by a replication process using an inorganic template. The inorganic template may be siliceous, and preferably is aluminosiliceous, such as a zeolite. Other inorganic materials may also be used as an inorganic template, according to an embodiment. The second category of carbon molecular sieve materials, not associated with the templated carbon according to the principles of the invention, is composed of ultramicroporous carbon with extraordinarily high surface areas and relatively uniform pore size and no inorganic template is utilized in preparing the ultramicroporous carbon. Both the first and the second categories of materials which are characterized in the art as carbon molecular sieves are further described in Oliveira et al., “Why are carbon molecular sieves interesting?” J. Braz. Chem. Soc., vol. 17, no. 1, pp. 16-29 (2006), which is incorporated by reference herein in its entirety.

Inorganic templates suitable for use herein to make a templated carbon, according to an embodiment, can be generally described as material having a molecular crystallographic structure which may include a natural or synthetic oxide of aluminum, silicon and combinations thereof. The molecular crystallographic structure may be based on three-dimensional framework based on tetrahedra. The tetrahedra may include silicon ions and/or aluminum ions surrounded by oxygen ions in a tetrahedral configuration. Each tetrahedral configuration may be bonded to two adjacent tetrahedra, linking them together in a polyhedral unit. The polyhedral units are equidimensional or have irregular dimensions in the framework and may form a sheet and/or a chain. The tetrahedra may be combined in a repeating structure which may be a ring structure. In addition, there are some inorganic templates that contain octahedral atoms, such as ETS-10, a titanosilicate, and there are also octahedral molecular sieves, such as manganese oxide.

According to another embodiment, inorganic templates suitable for use herein include ring structures which may be characterized by a number of tetrahedrally coordinated atoms (i.e., “T-atoms”) which are a member of a ring structure. The ring structures in the inorganic templates may include 4-, 6-, 8-, 10-, 12-, 14-, 16-, 18- and 20-T atoms or more. The inorganic templates may also include combinations of such ring structures and may include other sizes of ring structure as well. The number of T-atoms in a ring structure in an inorganic template may correlate with a dimension of a pore diameter within the ring structure. The pores are not always uniformly shaped and may be circular, elongated, etc. The ring structure may form a perimeter associated with the pore diameter within a ring structure.

The tetrahedra may combine in a repeating structure comprising various combinations of 4-, 6-, 8-, 10-, 12-, 14-, 16-, 18- and 20-T-atoms or more in the rings. The associated framework structure may be pore network of regular or irregular channels and cages. Pore dimensions may be based on the geometry of the tetrahedra, such as aluminosilicate tetrahedra, forming the zeolite channels or cages, with nominal openings of about 0.26 nm for 6-T-atom rings, about 0.40 nm for 8-T-atom rings, about 0.55 nm for 10-T-atom rings and about 0.65 to about 0.75 nm, including about 0.74 nm for 12-T-atom rings, based on the ionic radii for oxygen. According to an embodiment, inorganic templates which may be used to make templated carbon include zeolites having pores based on 8-T atom rings, 10-T atom rings, and 12-T atom rings.

The inorganic templates used to make a templated carbon in a C—S composite in composition 103 may be described by ring structures, ring structure sizes and/or average ring structure sizes associated with the inorganic templates. Inorganic templates having medium pore diameters (i.e., pore diameters in at least one dimension of about 5 to 6 angstroms) include 10-T atoms in the ring structures and are preferred. Inorganic templates having large pore diameters (i.e., pore diameter in at least one dimension of about 6 to 7.5 angstroms) include 12 T-atoms in the ring structures, and inorganic templates having larger (i.e., “extra-large”) pore diameters (i.e., pore diameters in at least one dimension of about 6.5 to 20 angstroms) include 14 to 20 T-atoms in the ring structures and are also preferred.

The polyhedral units may form cavities in the material of the inorganic templates. The polyhedral units may be linked building a framework structure of the molecular crystallographic structure, the framework structure forming interconnecting channels and caged cavities which are interconnected and may be regularly sized and shaped, irregularly sized and shaped and combinations thereof. The caged cavities and/or the interconnecting channels may form pores in the molecular crystallographic structure.

The molecular crystallographic structure of an inorganic template has a pore volume based on the pores within the remaining portion of the total volume occupied by the three dimensional framework structure of the inorganic template. The molecular crystallographic structure of an inorganic template also has a porosity based on the total volume of the inorganic template and the volume based on the pores within the remaining portion of the total volume occupied by the three dimensional framework structure of the inorganic template. The pore volume and porosity of a templated carbon may vary as desired by selecting materials of an inorganic template based on and complementary with the corresponding volumes of the inorganic template. For example, the porosity of an inorganic template chosen to form a templated carbon may be fully or partially complementary with the porosity of the templated carbon. The porosity of the templated carbon may range based, in part, on the porosity of the inorganic template used to form the templated carbon. In an embodiment, the porosity of the templated carbon may range from about 1 to 95% based on the total volume occupied by the templated carbon. In other embodiments, the porosity of the templated carbon may range from about 1 to 90%, 1 to 80%, 1 to 70%, 1 to 65%, 2 to 65%, 3 to 60%, 4 to 55% and from about 5 to 50%.

The pore volume of a templated carbon may be correlated with a wall thickness and/or an average wall thickness of a three dimensional framework in the inorganic microstructure of an inorganic template. An inorganic template used to make a templated carbon may be described in terms of the wall thickness and/or an average wall thickness in a framework structure. In an embodiment, a wall thickness and/or an average wall thickness in a framework structure of a templated carbon may range from about 1-60 Å, based, in part, on a three-dimensional framework of the inorganic template used to make the templated carbon. In other embodiments, a wall thickness and/or an average wall thickness in a framework structure of a templated carbon may range from about 2 to 50 Å, 3 to 40 Å, 4 to 35 Å, 5 to 30 Å, 5 to 25 Å, 5 to 20 Å, 5 to 18 Å, 5 to 16 Å, 5 to 14 Å, 5 to 12 Å and from about 5 to 10 Å. In a templated carbon, according to the embodiment, a wall thickness and/or an average wall thickness of less than 30 Å is preferred and a wall thickness and/or an average wall thickness of less than 20 Å is especially preferred.

A chemical description describing the molecular crystallographic structure may include AlO₄, SiO₄ and combinations thereof forming the tetrahedra. The silicon ions and/or aluminum ions surrounded by oxygen ions in a tetrahedral configuration in an inorganic template framework structure may have a negative charge. The negative charge may be balanced by cations housed in caged cavities and/or interconnecting channels of the inorganic template framework structure. According to an example, the framework structure of a zeolite material as an inorganic template may be described by the chemical formula: M_{2/n}O.Al₂O₃.xSiO₂.yH₂O wherein M is a cation of valence n, x is greater than or equal to about 2, and y is a number determined by the pore volume and the hydration state of the zeolite is generally from about 2 to about 8. M may be Na, Ca, K, Mg, Ba and combinations thereof.

Inorganic templates utilized for making the templated carbons may be characterized in terms of their framework density. The framework density is of the inorganic template may be correlated with the porosity and/or the pore volume of a templated carbon made using the inorganic template. The framework density is the number of tetrahedrally coordinated atoms (i.e., “T-atoms”) per 1000 cubic angstroms. As described above, the inorganic template has a molecular crystallographic structure including tetrahedra based on the tetrahedrons joined in a tetrahedral framework. A T-atom is the atom at the center of a tetrahedron in a tetrahedral framework and is bonded through four separate bonds with four oxygen atoms. A T-atom in an inorganic template is most commonly the element silicon (Si) or aluminum (Al). Other elements which may function as T-atoms in an inorganic template include Be, Mg, Zn, Co, Fe, Mn, B, Ga, Cr, Ge, Mn, Ti, P and Sn. Other elements which may also function as T-atoms and are known to those having ordinary skill in the art.

Inorganic templates suitable for use herein may have a framework density of 5, 8, 10, 11, 12, 13, 14, 15, 16, 17, 18, 19, 20, 21, 22, 23, 24, 25, 30, 35, 40, 45 and 50 T-atoms per 1000 cubic angstroms and higher. A framework density of an inorganic template is inversely related to the pore volume of the inorganic template and directly related to the pore volume of a templated carbon which is prepared based on the inorganic template. At the same time the carbon microstructure of the templated carbon is complementary to the inorganic microstructure of the inorganic template. For inorganic templates, such as zeolites, with fully crosslinked frameworks, the framework density values ordinarily range from about 12, for inorganic microstructures with a larger pore volume, to about 21 for inorganic microstructures with a smaller pore volume. Another range is from about 12 for inorganic microstructures with a larger pore volume, to about 17 for inorganic microstructures with a medium pore volume.

Inorganic templates suitable for use herein include naturally occurring zeolites. In naturally occurring zeolites, cations present (M) are principally represented by Na, Ca, K, Mg and Ba in proportions which reflect their approximate geochemical abundance. The cations (M) may be loosely bound to the structure and may be completely and/or partially replaced with other cations by conventional ion exchange. A zeolite framework structure may have corner-linked tetrahedra with Al or Si atoms at centers of the tetrahedra and oxygen atoms at the corners. In a zeolite, the term “silicon to aluminum ratio” or, equivalently, “Si/Al ratio” may be used to describe the ratio of silicon atoms to aluminum atoms.

Representative examples of zeolites suitable for use herein include (i) small pore diameter zeolites such as NaA (LTA), CaA (LTA), Erionite (ERI), Rho (RHO), ZK-5 (KFI) and chabazite (CHA); (ii) medium pore diameter zeolites such as ZSM-5 and silicalite (MFI), ZSM-11 (MEL), ZSM-22 10 (TON), and ZSM-48 (MRE); and (iii) large pore diameter zeolites such as zeolite beta (BEA), faujasite (FAU), mordenite (MOR), zeolite L (LTL), NaX (FAU), NaY (FAU), DA-Y (FAU) and CaY (FAU). The letters in parentheses give the framework structure type of the zeolite. As noted above, according to an embodiment, zeolites having medium and large pore diameters are especially useful as inorganic templates used in forming a templated carbon for a C—S composite in the composition 103.

TABLE I below identifies and shows the framework type of select zeolites having pore diameters based on their crystallographic structure including rings having 12 or more T-atoms in a ring.

TABLE I

| Framework | |
|---|---|
| Type Code | Material |
| AET | AIPO-8 |
| CFI | CIT-5 |
| CLO | Cloverite |
| DON | UTD-1F |
| ETR | ECR-34 |
| IRR | ITQ-44 |
| ITV | ITQ-37 |
| OSO | OSB-1 |
| SFH | SSZ-53 |
| SFN | SSZ-59 |
| UTL | IM-12 |
| VFI | VPI-5 |

Preferred zeolites suitable for use herein as inorganic template materials include those having medium pore diameter and/or large pore diameter dimensions. Zeolites of this type include silicalite, ZSM-5, faujasite, beta, zeolite L, and mordenite zeolites. The medium pore diameter zeolites have a framework structure including 10 T-atom rings with a pore diameter of about 0.55 nm, while large pore zeolites have a framework structure including 12 T-atom rings with a pore diameter of about 0.65 to about 0.75 nm. These zeolites may also include zeolite X, zeolite Y (faujasite), zeolite beta, mordenite, ZSM-5, ALPO₄-5, SBA-15, silicalite, mordenite, and zeolite L among others.

Other materials which may be utilized as inorganic template materials are certain types of inorganic molecular sieves, of which zeolites are a sub-type. While zeolites are aluminosilicate, this broader genus of inorganic molecular sieves may contain other elements in place of aluminum and silicon, but have analogous structures. Large pore diameter, hydrophobic molecular sieves which have similar properties to the preferred zeolites described above are suitable for use herein as inorganic template materials. Examples of such inorganic molecular sieves include without limitation Ti-Beta, B-Beta, and Ga-Beta silicates. These and related molecular sieves which may be utilized as inorganic template materials are further described in Szostak, “Molecular Sieves Principles of Synthesis and Identification”, (Van Nostrand 10 Reinhold, N.Y., 1989) which is incorporated by reference herein in its entirety.

Carbon precursors suitable for use herein include, but are not limited to, furfuryl alcohol; resorcinol-formaldehyde, pyrrhole, polyaniline, acrylonitrile, vinyl acetate, pyrene and others. These may be used as sources of carbon to form a carbon microstructure based on the inorganic microstructure of an inorganic templates Chemical vapor deposition may optionally be used after the first impregnation and/or stabilization of a first carbon precursor with one of the above and similar carbon sources as a second carbon precursor. One purpose may be to supplement the impregnating first carbon precursor with the aim of making the impregnation into the inorganic template more uniform. Stabilization, such as by polymerization of the carbon precursor may be performed generally by heating and/or other processes. The dissolution of the inorganic template may be accomplished using acids such as HF or bases such as NaOH. According to an example, a carbon containing gas may also be used to introduce a second carbon precursor into the inorganic template material. Possible carbon containing gases include methane, ethane, propane, butane, ethylene, propylene, acetylene, cyclohexane, and mixtures thereof.

Sulfur compounds which are suitable for making a C—S composite include molecular sulfur in its various allotropic forms and combinations thereof, such as “elemental sulfur”. Elemental sulfur is a common name for a combination of sulfur allotropes including puckered S₈ rings, and often including smaller puckered rings of sulfur. Other sulfur compounds which are suitable are compounds containing sulfur and one or more other elements. These include lithiated sulfur compounds, such as for example, Li₂S or Li₂S₂. A representative sulfur compound is elemental sulfur distributed by Sigma Aldrich as “Sulfur”, (Sigma Aldrich, 84683). Other sources of such sulfur compounds are known to those having ordinary skill in the art.

A C—S composite may made by various methods, including simply mixing, such as by dry grinding, templated carbon with sulfur compound. C—S composite may also be made by introducing the sulfur compound into the microstructure of the templated carbon utilizing such vehicles as heat, pressure, liquid (e.g., by dissolution of sulfur compound in carbon disulfide and impregnation by contacting the solution with the templated carbon), etc.

Useful methods for introducing sulfur compound into the templated carbon include melt imbibement and vapor imbibement. These are compositing processes for introducing the sulfur compound into the microstructure of the templated carbon utilizing such vehicles as heat, pressure, liquid, etc.

In melt imbibement, a sulfur compound, such as elemental sulfur can be heated above its melting point (about. 113° C.) while in contact with the templated carbon to impregnate it. The impregnation may be accomplished through a direct process, such as a melt imbibement of elemental sulfur, at a raised temperature, by contacting the sulfur compound and carbon at a temperature above 100° C., such as 160° C. A useful temperature range is 120° C. to 170° C.

Another imbibement process which may be used for making the C—S composite is vapor imbibement which involves the deposition of sulfur vapor. The sulfur compound may be raised to a temperature above 200° C., such as 300° C. At this temperature, the sulfur compound is vaporized and placed in proximity to, but not necessarily in direct contact with, the templated carbon.

These processes may be combined. For example, melt imbibement process can be followed by a higher temperature process. Alternatively, the sulfur compound can be dissolved in carbon disulfide to form a solution and the C—S composite can be formed by contacting this solution with the templated carbon. The C—S composite is prepared by dissolving sulfur compound in non-polar solvent such as toluene or carbon disulfide and contacted with the templated carbon. The solution or dispersion can be contacted, optionally, at incipient wetness to promote an even deposition of the sulfide compound into the pores of the templated carbon. Incipient wetness is a process in which the total liquid volume exposed to the templated carbon does not exceed the volume of the pores of that porous carbon material. The contacting process can involve sequential contacting and drying steps to increase the weight % loading of the sulfur compound.

Sulfur compound may also be introduced to the templated carbon by other methods. For example, sodium sulfide (Na₂S) can be dissolved in an aqueous solution to form sodium polysulfide. The sodium polysulfide can be acidified to precipitate the sulfur compound in the templated carbon. In this process, the C—S composite may require thorough washing to remove salt byproducts.

Suitable introducing methods include melt imbibement and vapor imbibement. One method of melt imbibement includes heating elemental sulfur (Li₂S will not melt under these conditions) and templated carbon at about 120° C. to about 170° C. in an inert gas, such as nitrogen. A vapor imbibement method may also be utilized. In the vapor imbibement method, sulfur vapor may be generated by heating a sulfur compound, such as elemental sulfur, to between the temperatures of about 120° C. and 400° C. for a period of time, such as about 6 to 72 hours in the presence of the templated carbon.

A C—S composite includes a templated carbon containing the sulfur compound situated in its carbon microstructure. The amount of sulfur compound which may be contained in the C—S composite (i.e., the sulfur compound loading in terms of the wt. % sulfur compound based on the total weight of the C—S composite) is dependent on the pore volume of the templated carbon. Accordingly, as the pore volume of the templated carbon increases, higher sulfur compound loading with more sulfur compound is possible. Thus, a sulfur compound loading of, for example, about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 85 wt. %, 90 wt. % or 95 wt. % may be used.

The composition 103 may be made by combining the C—S composite with a polymeric binder, and optionally other components including carbon black. The composition 103 may include various weight percentages of C—S composite and/or polymeric binder. The composition 103 may optionally include carbon black in addition to the C—S composite and polymeric binder.

A polymeric binder which may be utilized for making the composition 103 includes polymers exhibiting chemical resistance, heat resistance as well as binding properties, such as polymers based on alkylenes, oxides and/or fluoropolymers. Examples of these polymers include polyethylene oxide (PEO), polyisobutylene (PIB), and polyvinylidene fluoride (PVDF). A representative polymeric binder is polyethylene oxide (PEO) with an average M_{w} of 600,000 distributed by Sigma Aldrich as “Poly(ethylene oxide)”, (Sigma Aldrich, 182028). Another representative polymeric binder is polyisobutylene (PIB) with an average M_{w} of 4,200,000 distributed by Sigma Aldrich as “Poly(isobutylene)”, (Sigma Aldrich, 181498). Polymeric binders which are suitable for use herein are also described in U.S. Published Patent Application No. US2010/0068622, which is incorporated by reference herein in its entirety. Other sources of polymeric binders are known to those having ordinary skill in the art.

Carbon blacks which are suitable for making the composition 103 include carbon substances exhibiting electrical conductivity and generally having a lower surface area and lower pore volume relative to the templated carbon described above. Carbon blacks typically are colloidal particles of elemental carbon produced through incomplete combustion or thermal decomposition of gaseous or liquid hydrocarbons under controlled conditions. Other conductive carbons which are also suitable are based on graphite. Suitable carbon blacks include acetylene carbon blacks which are preferred. A representative carbon black is SUPER C65 distributed by Timcal Ltd. and having BET nitrogen surface area of 62 m²/g carbon black measured by ASTM D3037-89. Other commercial sources of carbon black, and methods of manufacturing or synthesizing them, are known to those of ordinary skill in the art.

Carbon blacks which are suitable for use herein include those having a surface area ranging from about 10 to 250 square meters per gram carbon black, about 30 to 200 square meters per gram, about 40 to 150 square meters per gram, about 50 to 100 square meters per gram and about 60 to 80 square meters per gram carbon black.

The C—S composite is generally present in the composition 103 in an amount which is greater than 50 percent by weight of the composition 103. Higher loading with more C—S composite is possible and may be preferred. Thus, a C—S composite loading of, for example, about 55 wt. %, 60 wt. %, 65 wt. %, 70 wt. %, 75 wt. %, 80 wt. %, 82.5 wt. %, 85 wt. %, 82.5 wt. %, 90 wt. %, 91 wt. %, 92 wt. %, 93 wt. %, 94 wt. %, 95 wt. %, 98 wt. %, or 99 wt. % C—S composite may be used. According to an embodiment, about 50 to 99 wt. % C—S composite may be used. In another embodiment, about 70 to 95 wt. % C—S composite may be used.

A polymeric binder is generally present in the composition 103 in an amount which is greater than 1 percent by weight of the composition 103. Higher loading with more polymeric binder is possible. Thus, a polymeric binder loading of, for example, about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 16 wt. %, or 17.5 wt. % polymeric binder may be used. According to an embodiment, about 1 to 17.5 wt. % polymeric binder may be used. In another embodiment, about 4 to 12 wt. % polymeric binder may be used.

According to an embodiment, carbon black may be present in the composition 103 in an amount which is greater than about 0.01 percent by weight of the composition 103. Higher loading with more carbon black is possible and may be preferred. Thus, a carbon black loading of, for example, about 0.1 wt. %, 1 wt. %, 2 wt. %, 3 wt. %, 4 wt. %, 5 wt. %, 6 wt. %, 8 wt. %, 10 wt. %, 12 wt. %, 14 wt. %, 15 wt. %, or 20 wt. % carbon black may be used. According to an embodiment, about 0.01 to 15 wt. % carbon black may be used. In another embodiment, about 5 to 10 wt. % carbon black may be used.

According to an embodiment, the composition 103 may be made by combining a C—S composite formed by a compositing process with a polymeric binder, and optionally a carbon black by conventional mixing or grinding processes. A solvent, preferably an organic solvent, such as toluene, alcohol, or n-methylpyrrolidone (NMP) may optionally be utilized depending on the polymeric binder system. The solvent should preferably not react with the binder so as to break the polymeric binder down, or significantly alter it.

Also, a porogen (i.e., a void or pore generator) may be included in the composition 103 which may be formed into an electrode. A porogen is any additive which can be removed by a chemical or thermal process to leave behind a void, changing the pore structure of the electrode. This level of porosity control may be utilized in terms of managing mass transfer in an electrode. For example, a porogen may be a carbonate, such as calcium carbonate powder, which is added with other components such as a C—S composite, polymeric binder and an optional conductive carbon black, onto an aluminum foil current collector to form an electrode. It may be desirable to add the porogen in higher concentrations closer to the current collector, and so create a gradient in the direction of the thickness of the electrode. Once the porogen is in place in the formed electrode, it may then be removed from by washing with dilute acid to leave a void or pore. The type of porogen and the amount can be varied to control the porosity of the electrode.

Referring again to FIG. 1, depicted is the positive electrode 102 that is made incorporating the composition 103 as described above. The formed positive electrode 102 may be utilized in the cell 100 in conjunction with a negative electrode, such as the lithium-containing negative electrode 101 described above. According to different embodiments, the negative electrode 101 may contain lithium or a lithium alloy. In another embodiment, the negative electrode 101 may contain graphite or some other non-lithium material. According to this embodiment, the positive electrode 102 is formed to include some form of lithium, such as lithium sulfide (Li₂S). In this example, the C—S composite may be lithiated utilizing lithium sulfide which is incorporated into the templated carbon to make the C—S composite according to the embodiment.

A porous separator, such as porous separator 105, may be constructed from, for example, using porous laminates made from polymers such as polyvinylidene fluoride (PVDF), polyvinylidene fluoride co-hexafluoropropylene (PVDF-HFP), polyethylene (PE), polypropylene (PP).

Positive electrode 102, negative electrode 101 and porous separator 105 are in contact with a lithium ion-containing electrolyte medium, such as a cell solution containing solvent and electrolyte. In one embodiment, the lithium-containing electrolyte medium is a liquid. In another embodiment, the lithium-containing electrolyte medium is a solid. In yet another embodiment, the lithium-containing electrolyte medium is a gel.

The positive electrode 102 may include a circuit contact, such as circuit contact 104, and be incorporated into a Li—S battery by fabricating a Li—S cell including the positive electrode 102. The electrode 102 may be formed to include the circuit contact 104 utilizing manufacturing methods, such as pressure forming and others, which are well known to those of ordinary skill in the art.

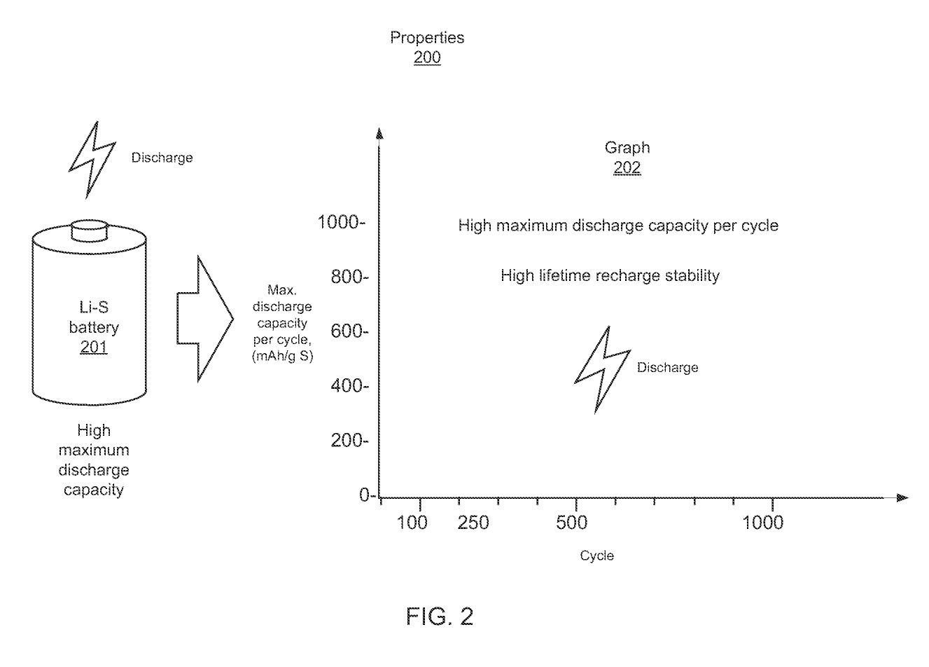

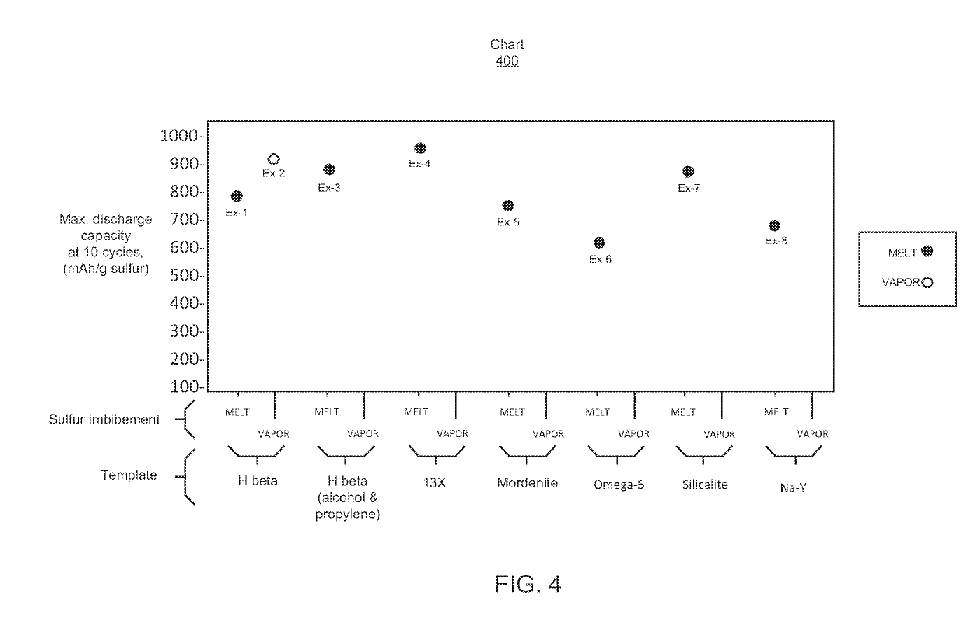

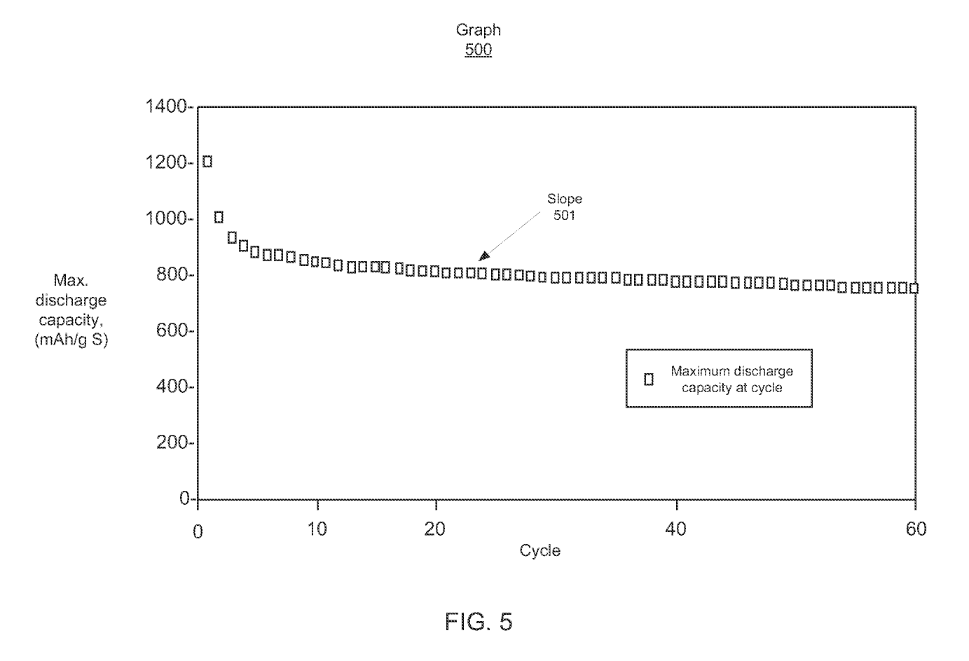

Referring to FIG. 2, depicted is a context diagram illustrating properties 200 of a Li—S battery 201 including a cell, such as cell 100, having a positive electrode, such as positive electrode 102, incorporating a composition, such as composition 103 comprising a C—S composite including templated carbon, according to the principles of the invention. The context diagram of FIG. 2 demonstrates properties 200 of the Li—S battery 201, having a high maximum discharge capacity associated with its discharge. FIG. 2 also depicts a graph 202 demonstrating maximum discharge capacity per cycle with respect to a number of charge-discharge cycles of the Li—S battery 201. The Li—S battery 201 also exhibits high lifetime recharge stability and a high maximum discharge capacity per charge-discharge cycle. All these properties of the Li—S battery 201 are demonstrated in greater detail below through the specific examples and the data depicted in FIG. 4 and FIG. 5.

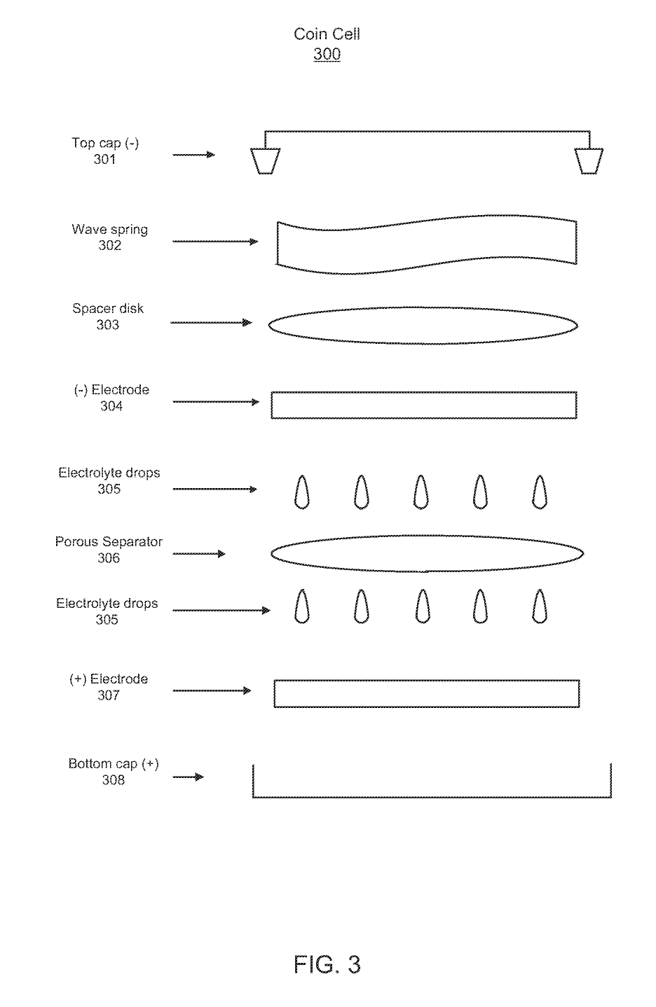

Referring to FIG. 3, depicted is a coin cell 300 which is operable as an electrochemical measuring device for testing compositions and electrodes in a Li—S cell of a Li—S battery. The function and structure of the coin cell 300 are analogous to those of the cell 100 depicted in FIG. 1. The coin cell 300 and the cell 100 both utilize a lithium ion-containing electrolyte medium, such as a cell solution including solvent and electrolyte.

The lithium ion electrolyte may be non-carbon-containing (i.e. inorganic). For example, the lithium ion electrolyte may be a lithium salt of such counter ions as hexachlorophosphate (PF₆⁻), perchlorate, chlorate, chlorite, perbromate, bromate, bromite, periodiate, iodate, aluminum fluorides (e.g. AlF₄⁻), aluminum chlorides (e.g. Al₂Cl₇⁻, and AlCl₄⁻), aluminum bromides (e.g. AlBr₄⁻), nitrate, nitrite, sulfate, sulfites, permanganate, ruthenate, perruthenate and the polyoxometallates.

In another embodiment, the lithium ion electrolyte may be carbon containing. For example, the lithium ion salt may contain organic counter ions such as carbonate, the carboxylates (e.g. formate, acetate, propionate, butyrate, valerate, lactacte, pyruvate, oxalate, malonate, glutarate, adipate, deconoate and the like), the sulfonates (e.g. CH₃SO₃⁻, CH₃CH₂SO₃⁻, CH₃(CH₂)₂SO₃⁻, benzene sulfonate, toluenesulfonate, dodecylbenzene sulfonate and the like. The organic counter ion may include fluorine atoms. For example, the lithium ion electrolyte may be a lithium ion salt of such counter anions as the fluorosulfonates (e.g. CF₃SO₃⁻, CF₃CF₂SO₃⁻, CF₃(CF₂)₂SO₃⁻, CHF₂CF₂SO₃⁻ and the like), the fluoroalkoxides (e.g. CF₃O⁻, CF₃CH₂O⁻, CF₃CF₂O⁻ and pentafluorophenolate), the fluoro carboxylates (e.g. trifluoroacetate and pentafluoropropionate) and fluorosulfonimides (e.g. (CF₃SO₂)₂N⁻). Other electrolytes which are suitable for use herein are disclosed in U.S. Published Patent Applications 2010/0035162 and 2011/00052998 both of which are incorporated herein by reference in their entireties.

The electrolyte medium may exclude a protic solvent, since protic liquids are generally reactive with the lithium anode. Solvents are preferable which may dissolve the electrolyte salt. For instance, the solvent may include an organic solvent such as polycarbonate, ether or mixtures thereof. In other embodiments, the electrolyte medium may include a non-polar liquid. Some examples of non-polar liquids include the liquid hydrocarbons (such as pentane, hexane and the like).

Electrolyte preparations suitable for use in the cell solution may include one or more electrolyte salts in a nonaqueous electrolyte composition. Suitable electrolyte salts include without limitation: lithium hexafluorophosphate, Li PF₃(CF₂CF₃)₃, lithium bis(trifluoromethanesulfonyl)imide, lithium bis(perfluoroethanesulfonyl)imide, lithium (fluorosulfonyl) (nonafluoro-butanesulfonyl)imide, lithium bis(fluorosulfonyl)imide, lithium tetrafluoroborate, lithium perchlorate, lithium hexafluoroarsenate, lithium trifluoromethanesulfonate, lithium tris(trifluoromethanesulfonyl)methide, lithium bis(oxalato)borate, lithium difluoro(oxalato)borate, Li₂B₁₂F₁₂₋ₓHₓ where x is equal to 0 to 8, and mixtures of lithium fluoride and anion receptors such as B(OC₆F₅)₃. Mixtures of two or more of these or comparable electrolyte salts may also be used. In an embodiment, the electrolyte salt is lithium bis(trifluoromethanesulfonyl)imide. The electrolyte salt may be present in the nonaqueous electrolyte composition in an amount of about 0.2 to about 2.0 M, more particularly about 0.3 to about 1.5 M, and more particularly about 0.5 to about 1.2 M.

### EXAMPLES

Sample templated carbons, sample C—S composites, sample compositions 103 and sample coin cells were prepared according to the examples below and used to test the composition 103 in each example. In each of the examples, furfuryl alcohol was used as the carbon precursor and elemental sulfur was used as the sulfur compound in making the C—S composite. In making the composition 103, PVDF was used as the binder and SUPER C65 was used as the carbon black. These compositions 103 of the examples were incorporated into the positive electrode 307 in the coin cell 300. The composition 103 and positive electrode 307 of each example was cycled at room temperature between 1.5 and 3.0 V (vs. Li/Li⁰) at C/5 (based on 1675 mAh/g S for the charge capacity of elemental sulfur). This is equivalent to a current of 335 mAh/g S in the positive electrode (positive electrode 307).

Table II below lists summarized information relating to all of the following specific examples. Reference is also made to the following specific examples below.

TABLE II

| | | | | | Templated |
|---|---|---|---|---|---|
| | | | C—S | Templated | Carbon |
| | | | Composite | Carbon | Surface |
| Ex. | Inorganic | Framework | Preparation | Pore volume | Area |
| No. | Template | Density | Process | (cc/g) | (m2/g) |
| 1 | H-beta | 15.1 | Melt | 1.389 | 926 |
| 2 | H-beta | 15.1 | Vapor | 1.389 | 926 |
| 3 | H-beta | 15.1 | Melt, | 1.078 | 1,521 |
| | | | propylene | | |
| 4 | 13-X | 12.7 | Melt | 0.672 | 1,187 |
| 5 | Mordenite | 17.2 | Melt | 0.416 | 216 |
| 6 | Omega-5 | 16.1 | Melt | 2.352 | 872 |
| 7 | Silicalite | 17.9 | Melt | 0.598 | 976 |
| 8 | Na—Y | 12.7 | Melt | 0.633 | 671 |

### Example 1

### Synthesis of Templated Carbon

A sample of H-beta zeolite powder (framework density 15.1) was treated by stirring for five days in excess furfuryl alcohol under reduced pressure. After the five days it was filtered and washed with excess mesitylene. The material was placed in a vertical tube furnace with nitrogen flow of 60 mL/min, heated for two hours at 150° C. to polymerize furfuryl alcohol in the zeolite pores and then heated for four hours at 700° C. It was then washed with excess 20% HF and excess 20% HCl for four washings waiting one day between each wash. BET measurements show the resulting material to have a surface area of 926 m²/g and a pore volume of 1.389 cc/g.

Preparation of C—S Composite:

1.0 grams of the templated carbon, described above, was combined with 0.37 grams of elemental sulfur and ground in a FRITSCH PULVERISETTE mill for ten minutes. The material was loaded in an alumina boat and placed in a horizontal tube furnace with a 4″ diameter quart tube, which was purged with flowing N₂ (˜0.7 l/minute). The sample was then heated according to the following protocol to create the C—S composite. Heated to 160° C. (1.13° C./minute) held at 160° C. (1 hour) then cooled to room temperature (furnace cool). The sulfur compound loading of the C—S composite was 26.95 wt. %.

Preparation of Composition:

TIMCAL SUPER C65 carbon was blended and dispersed in n-methylpyrrolidone (NMP) to create a 15 wt. % slurry. 1.47 of polyvinylidene difluoride (PVDF) solution (12 wt. % of PVDF in n-methyl pyrollidone) was combined with 0.782 grams of the SUPER C65-NMP slurry and placed in a planetary centrifugal vacuum mixer, THINKY ARE-310. The slurry was mixed at 2,000 rpm for approximately two minutes. To this formulation, 1.17 grams of the C—S composite (as described above) was added along with an additional 1.58 grams of n-methylpyrrolidone and the material was mixed for a second time in the THINKY mixer for two minutes.

Preparation of Positive Electrode:

An electrode was formed by coating this formulation on an aluminum foil with a 10 mil drawdown blade. A single sided carbon coated 1 mil Al foil was used as the substrate for the draw down. The coated area was approximately 3″×4″. After drawing down the formulation, containing the templated C—S composite, PVDF binder and SUPER C65 carbon were placed onto the carbon coated foil; the electrode was placed in a room temperature vacuum oven and heated to 70° C. over a period of 70 minutes. The electrode was subsequently held at 70° C. for 20 minutes while under vacuum before cooling to room temperature under vacuum.

Electrochemical Evaluation:

A coin cell 300 was prepared using the positive electrode 307 as described above with respect to FIG. 3 for testing. A preparation of electrolyte including 2.87 grams of lithium bis(trifluoromethanesulfonyl)imide was combined with 10 milliters of bis(2-methoxyethyl)ether to create a 1 M electrolyte solution. A 14.29 mm diameter circular disk was punched from the electrode described in the previous section and was used as the positive electrode 307. The final weight of the electrode (14.29 mm in diameter, subtracting the weight of the aluminum current collector) is 3.6 mg. This corresponds to a calculated weight of 0.77 mg of elemental sulfur on the electrode. The coin cell 300 included the positive electrode 307, a 19 mm diameter circular disk of CELGARD 2300 porous separator 306 (Celgard, LLC), a 15.88 mm diameter circular disk of 3 mil thick lithium foil as a negative electrode 304 (Chemetall Foote Corp.) and a few electrolyte drops 305 of the nonaqueous electrolyte sandwiched in a Hohsen 2032 stainless steel coin cell can with a 1 mil thick stainless steel spacer disk and wave spring (Hohsen Corp.). Samples were cycled at room temperature between 1.5 and 3.0 V (vs. Li/Li⁰) at C/5 (based on 1675 mAh/g S for the charge capacity of elemental sulfur). This is equivalent to a current of 335 mAh/g S in the positive electrode (positive electrode). The maximum charge capacity on discharge at cycle 10 was 782 mAh/g S.

### Example 2

### Synthesis of Templated Carbon

A sample of H-beta zeolite powder (framework density 15.1) was treated by stirring for five days in excess furfuryl alcohol under reduced pressure. After the five days it was filtered and washed with excess mesitylene. The material was placed in a vertical tube furnace with nitrogen flow of 60 mL/min, heated for two hours at 150° C. to polymerize furfuryl alcohol in the zeolite pores and then heated for four hours at 700° C. It was then washed with excess 20% HF and excess 20% HCl for four washings waiting one day between each wash. BET measurements showed the resulting material to have a surface area of 926 m²/g and a pore volume of 1.389 cc/g.

Preparation of C—S Composite:

Approximately 0.5 cc of the carbon black was placed in a 30 ml glass vial and loaded into an autoclave which had been charged with approximately 100 grams of elemental sulfur. The templated carbon was prevented from being in physical contact with the elemental sulfur powder but there was access of sulfur vapor to the powder. The autoclave was closed, purged with nitrogen, and then heated to 300 C for 24 hours under a static atmosphere. The final sulfur compound loading of the C—S composite was 38.6 wt. %.

Preparation of Composition:

A procedure similar to that described in example 1 was used, with the following differences. 0.782 grams of 15 wt. % SUPER C65 in NMP was combined with 1.47 grams of PVDF binder (12 wt. % solution in NMP) and blended for two minutes on the THINKY mixer. In a subsequent step, 1.17 grams of the templated carbon was imbibed with sulfur was added along with an additional 1.58 gram of n-methylpyrrolidone. The material was blended on the THINKY mixer for an additional two minutes to create the final formulation.

Preparation of Positive Electrode:

The same procedures were used as described in example 1 for the fabrication and evaluation of the coin cell Li—S battery. The final weight of the electrode (14.29 mm in diameter, subtracting the weight of the aluminum current collector) is 6.0 mg. This corresponds to a calculated weight of 1.84 mg of elemental sulfur on the electrode.

Electrochemical Evaluation:

The maximum charge capacity on discharge at cycle 10 was 911 mAh/g S.

### Example 3

### Synthesis of Templated Carbon

A sample of H-beta zeolite powder (framework density 15.1) was treated by stirring for five days in excess furfuryl alcohol under reduced pressure. After the five days it was filtered and washed with excess mesitylene. The material was placed in a vertical tube furnace with nitrogen flow of 60 mL/min, heated for two hours at 150° C. to polymerize furfuryl alcohol in the zeolite pores and then heated for four hours at 700° C. The resulting product was heated 800° C. for four hours in a flowing 2% propylene atmosphere. It was then washed with excess 20% HF and excess 20% HCl for four washings waiting one day between each wash. BET measurements showed the resulting material to have a surface area of 1521 m²/g and a pore volume of 1.078 cc/g.

Preparation of C—S Composite:

A procedure similar to that described in example 1 was used. Hence, 1.0 grams of the templated carbon described above was combined with 0.37 grams of elemental sulfur and ground in the FRITSCH PULVERISETTE mill for ten minutes. The material was loaded in an alumina boat and heated as described above in example 1. The final sulfur compound loading of the C—S composite was 26.95 wt. %.

Preparation of Composition:

A procedure identical to those described in example 1 was used to prepare the composition for the positive electrode.

Preparation of Positive Electrode:

The same procedures were used as described in example 1 for the fabrication and evaluation of the coin cells. The final weight of the electrode (14.29 mm in diameter, subtracting the weight of the aluminum current collector) is 8.9 mg. This corresponds to a calculated weight of 1.93 mg of elemental sulfur on the electrode.

Electrochemical Evaluation:

The maximum charge capacity on discharge at cycle 10 was 883 mAh/g S.

### Example 4

### Synthesis of Templated Carbon

A sample of 13× zeolite (framework density 12.7) was calcined for 8 hours at 500° C. to dry. It was then treated by stirring for five days in about 200 mL furfuryl alcohol under reduced pressure. After the five days, it was filtered and washed with excess mesitylene and filtered again. The material was placed in a tube furnace with nitrogen flow of 60 mL/min and heated for two hours at 150° C. to polymerize the furfuryl alcohol. The material was then heated for four hours at 700° C. In plastic lab-ware the material was washed with excess 20% HF and excess 20% HCl for four washings allowing it to soak in each washing, followed by filtering, and rinsing with water between each wash. After the final wash, the material was rinsed with water until the pH is almost neutral. The material was vacuum oven dried at 50° C. overnight. BET measurements showed the resulting material to have a surface area of 1,187 m²/g and a pore volume of 0.672 cc/g.

Preparation of C—S Composite:

0.935 grams of the templated carbon described above was combined with 0.28 grams of elemental sulfur and ground in a FRITSCH PULVERSITE mill for ten minutes. The material was loaded in an alumina boat and heated as described in example 1. The final sulfur compound loading of the C—S composite was 23.1 wt. %.

Preparation of Composition:

A similar procedure to that described in example 1 was used, with the following differences. 0.117 of SUPER C65 carbon black was combined with 1.47 grams of polyvinylidenedifluoride solution (12 wt. % in n-methylpyrrolidone). The mixture was blended in the THINKY mixer. To this mixture, 1.17 grams of the templated C—S composite (described above) and 2.25 grams of n-methylpyrrolidone was added. The mixture was blended for an additional 2 minutes, but because of its consistency, an additional 0.35 grams of n-methylpyrrolidone was added and the material cast onto the carbon coated Al foil to create an electrode, as described in example 1.

Preparation of Positive Electrode:

The same procedures were used as described in example 1 for the fabrication and evaluation of the coin cells. The final weight of the electrode (14.29 mm in diameter, subtracting the weight of the aluminum current collector) is 3.7 mg. This corresponds to a calculated weight of 0.69 mg of elemental sulfur on the electrode.

Electrochemical Evaluation:

The maximum charge capacity on discharge at cycle 10 was 957 mAh/g S.

### Example 5

### Synthesis of Templated Carbon

A sample of CBV-90A (i.e., Mordenite 90A) (framework density 17.2) was calcined for 8 hours at 500° C. to dry. It was then treated by stirring for several days in excess furfuryl alcohol under reduced pressure. After the several days it was filtered and washed with excess mesitylene. The material was placed in a vertical tube furnace with nitrogen flow of 60 mL/min and heated for two hours at 150° C. to polymerize furfuryl alcohol in the zeolite pores; then heated for four hours at 700° C. In plastic labware the material was washed with excess 20% HF and excess 20% HCl for four washings followed by rinsing with water between each wash. The material was vacuum oven dried. BET measurements showed the resulting material to have a surface area of 216 m²/g and a pore volume of 0.461 cc/g.

Preparation of C—S Composite:

A procedure similar to that described in example 1 was used. 0.491 grams of the of the templated carbon was combined with 0.204 grams of elemental sulfur and processed according the procedures of example 1. The material was loaded in an alumina boat and heated as described in example 1. The final sulfur compound loading of the C—S composite was 32.4 wt. %.

Preparation of Composition:

A similar procedure to that described in example 1 was used, with the following differences. 0.063 grams of SUPER C65 carbon black was combined with 0.79 grams of polyvinylidenedifluoride solution (12 wt. % in n-methylpyrrolidone. The mixture was blended in the THINKY mixer. To this mixture, 0.63 grams of the C—S composite (described above) and 1.2 grams of n-methylpyrrolidone was added. The mixture was blended for an additional 2 minutes and the formulation as cast onto the carbon coated Al foil to create an electrode, as described in example 1.

Preparation of Positive Electrode:

The same procedures were used as described in example 1 for the fabrication and evaluation of the coin cells. The final weight of the electrode (14.29 mm in diameter, subtracting the weight of the aluminum current collector) is 5.5 mg. This corresponds to a calculated weight of 1.42 mg of elemental sulfur on the electrode.

Electrochemical Evaluation:

The maximum charge capacity on discharge at cycle 10 was 747 mAh/g S.

### Example 6

### Synthesis of Templated Carbon

A sample of ELZ Omega-5 (framework density 16.1) was calcined for 8 hours at 500° C. to dry. It was then treated by stirring for several days in excess furfuryl alcohol under reduced pressure. It was then filtered and washed with excess mesitylene. The material was placed in a vertical tube furnace with nitrogen flow of 60 mL/min and heated for two hours at 150° C. to polymerize furfuryl alcohol in the zeolite pores. It was then heated for four hours at 700° C. In plastic labware the material was washed with excess 20% HF and excess 20% HCl for four washings allowing the material to soak one day each, filter, then rinsing with water between each wash. The material was vacuum oven dried at 50° C. BET measurements showed the resulting material to have a surface area of 872 m²/g and a pore volume of 2.352 cc/g.

Preparation of C—S Composite:

A procedure similar to that described in example 1 was used. 0.985 grams of the templated carbon was combined with 2.53 grams of elemental sulfur and processed according the procedures of example 1. The material was loaded in an alumina boat and heated as described in example 1. The final sulfur compound loading of the C—S composite was 77.1 wt. %.

Preparation of Composition:

A similar procedure to that described in example 1 was used, with the following differences. 0.117 grams of SUPER C65 carbon black was combined with 1.47 grams of polyvinylidenedifluoride solution (12 wt. % in n-methylpyrrolidone). The mixture was blended in the THINKY mixer. To this mixture, 1.17 grams of the templated C—S composite described above and 2.25 grams of n-methylpyrrolidone was added. The mixture was blended for an additional 2 minutes and the formulation was cast onto the Al foil to create an electrode, as described in example 1.

Preparation of Positive Electrode:

The same procedures were used as described in example 1 for the fabrication and evaluation of the coin cells. The final weight of the electrode (14.29 mm in diameter, subtracting the weight of the aluminum current collector) is 2.4 mg. This corresponds to a calculated weight of 1.48 mg of elemental sulfur on the electrode.

Electrochemical evaluation: The maximum charge capacity on discharge at cycle 10 was 639 mAh/g S.

### Example 7

### Synthesis of Templated Carbon

A sample of S-115 (LA) Silicalite (framework density 17.9), was treated by stirring for five days in excess furfuryl alcohol under reduced pressure. After the five days it was filtered and washed with excess mesitylene. The material was placed in a vertical tube furnace with nitrogen flow of 60 mL/min and heated for two hours at 150° C. to polymerize furfuryl alcohol in the zeolite pores; it was then heated for four hours at 700° C. In plastic labware the material was washed with excess 20% HF and excess 20% HCl for four washings rinsing with water between each wash. The material was vacuum dried at 50° C. BET measurements showed the resulting material to have a surface area of 976 m²/g and a pore volume of 0.598 cc/g.

Preparation of C—S Composite:

A procedure similar to that described in example 1 was used. 0.462 grams of the templated carbon was combined with 0.11 grams of elemental sulfur and processed according the procedures of example 1. The final sulfur compound loading of the C—S composite was 19.5 wt. %.

Preparation of Composition:

A similar procedure to that described in example 1 was used, with the following differences. 0.056 grams of SUPER C65 carbon black was combined with 0.704 grams of polyvinylidenedifluoride solution (12 wt. % in n-methylpyrrolidone). The mixture was blended in the THINKY mixer. To this mixture, 0.564 grams of the templated C—S composite described above and 1.079 grams of n-methylpyrrolidone was added. The mixture was blended for an additional 2 minutes and the formulation was cast onto the Al foil to create an electrode, as described in example 1.

Preparation of Positive Electrode:

The same procedures were used as described in example 1 for the fabrication and evaluation of the coin cells. The final weight of the electrode (14.29 mm in diameter, subtracting the weight of the aluminum current collector) was 2.5 mg. This corresponds to a calculated weight of 0.39 mg of elemental sulfur on the electrode.

Electrochemical Evaluation:

The maximum charge capacity on discharge at cycle 10 was 874 mAh/g S.

### Example 8

### Synthesis of Templated Carbon

A sample of Na—Y powder (framework density 12.7) was calcined for 8 hours at 500° C. and held at 110° C. It was then treated by stirring for five days in excess furfuryl alcohol under reduced pressure. After the five days it was filtered and washed with excess mesitylene. The material was placed in a vertical tube furnace with nitrogen flow of 60 mL/min, heated for two hours at 150° C. to polymerize furfuryl alcohol in the zeolite pores and then heated for four hours at 700° C. It was then washed with excess 20% HF and excess 20% HCl for four washings waiting one day between each wash. After one final washing with 20% HCl, the sample was rinsed with water and dried at 50° C. BET measurements showed the resulting templated carbon to have a surface area of 671 m²/g and a pore volume of 0.663 cc/g.

Preparation of C—S Composite:

A procedure similar to that described in example 1 was used. Hence, 0.5 grams of the templated carbon described above was combined with 0.07 grams of elemental sulfur and ground in an agate mortar and pestle for about five minutes. The material was loaded in an alumina boat and heated as described in example 1. The final sulfur compound loading of the C—S composite was 12.3 wt. %.

Preparation of Composition:

A similar procedure to that described in example 1 was used, with the following differences. 0.053 of Super C65 carbon black was combined with 0.66 grams of polyvinylidenedifluoride solution (12 wt. % in n-methylpyrrolidone). The mixture was blended in the THINKY device. To this mixture, 0.528 grams of the sulfur-carbon replica composite (described above) and 1.01 grams of n-methylpyrrolidone was added. The mixture was blended for an additional 2 minutes. The composition was cast onto the carbon coated Al foil to create an electrode, as described in example 1.

Preparation of Positive Electrode:

The same procedures were used as described in example 1 for the fabrication and evaluation of the coin cells. The final weight of the electrode (14.29 mm in diameter, subtracting the weight of the aluminum current collector) was 4.0 mg. This corresponds to a calculated weight of 0.426 mg of elemental sulfur on the electrode.

Electrochemical Evaluation:

The maximum charge capacity on discharge at cycle 10 was 670 mAh/g S.

Referring to FIG. 4, depicted is a chart 400 demonstrating the measured maximum charge capacity on discharge at 10 cycles associated with the different compositions 103 with templated carbons based on the inorganic templates of the specific examples at 10 cycles. The specific results as well as the specific materials and procedures used in the various examples are described above with respect to each example reflected in chart 400 of FIG. 4.

Referring to FIG. 5, depicted is a graph 500 demonstrating the measured maximum charge capacity on discharge at cycles 1 through 60 for coin cell 300 tested in example 3, in which the templated carbon was made using an inorganic template H-beta zeolite. The carbon microstructure structure of the templated carbon was made using furfuryl alcohol carbon precursor which is polymerized and treated with propylene gas. Sulfur imbibement was done by the melt process described in example 3 above. The same coin cell wand testing procedures were used as described in example 3 above for the fabrication and evaluation of the coin cell 300. The measured maximum charge capacity on discharge at cycles 1-60 in terms of mAh/gram S is demonstrated in the graph 500. The slope 501 of a line approximating the line formed from the measured values between cycles 10 and 60 may be calculated as the slope of the line intersecting the measured value capacity at cycle 10 and 60. The slope 501 shows that a positive electrode incorporating a composition comprising a C—S composite including templated carbon, according to the principles of the invention, exhibits significant stability.

TABLE III below shows the slopes between 10 and 80 cycles associated with other specific examples described above and expressed in terms of lost mAh/g S per cycle. Example 6 is not included in Table III as cycle data to 80 cycles was not developed for this specific example.

TABLE III

| | Decay rate | | | | | | |
|---|---|---|---|---|---|---|---|
| | in mAh/g S | capacity | capacity | mg of | | | |
| Ex. | per cycle | at cycle | at cycle | Sulfur | mAh/g | mAh/g | mAh/g |
| No. | (slope) | 10 | 80 | loaded | S initial | S final | S lost |
| 1 | 3.34 | 0.6039 | 0.4232 | 0.7719 | 782.31 | 548.23 | 234.09 |
| 2 | 9.66 | 1.6730 | 0.4320 | 1.8359 | 911.27 | 235.31 | 675.96 |
| 3 | 4.28 | 1.7031 | 1.1254 | 1.9286 | 883.06 | 583.54 | 299.52 |
| 4 | 11.92 | 0.5873 | 0.0752 | 0.6138 | 956.90 | 122.49 | 834.41 |
| 5 | 3.52 | 1.0643 | 0.7128 | 1.4245 | 747.13 | 500.40 | 246.73 |
| 6 | n/a | n/a | n/a | n/a | n/a | n/a | n/a |
| 7 | 10.76 | 0.3409 | 0.0473 | 0.3900 | 874.20 | 121.33 | 752.87 |

Utilizing Li—S cell 100 incorporating a positive electrode incorporating composition 103 comprising a C—S composite including templated carbon, according to the principles of the invention, provides a high maximum discharge capacity Li—S battery. Li—S cells incorporating compositions with C—S composites including templated carbon may be utilized in a broad range of Li—S battery applications in providing a source of potential power for many household and industrial applications. The Li—S batteries incorporating these compositions are especially useful as power sources for small electrical devices such as cellular phones, cameras and portable computing devices and may also be used as power sources for car ignition batteries and for electrified cars.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to the figures, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant art who are not familiar with patent or legal terms or phraseology, to determine quickly from a cursory inspection the nature and essence of this technical disclosure. The Abstract is not intended to be limiting as to the scope of the present invention in any way.

What is claimed is:

1. A composition comprising:
about 1 to 17.5 wt. % polymeric binder; and
about 50 to 99 wt. % carbon-sulfur composite, the carbon-sulfur composite comprising templated carbon having
a surface area of about 50 to 4,000 square meters per gram templated carbon, and
a pore volume of about 0.5 to 6 cubic centimeters per gram templated carbon,
wherein the templated carbon has a carbon microstructure that is complementary with an inorganic microstructure, characterized by a three-dimensional framework, of an inorganic template used in a process for making the templated carbon, and
about 5 to 95 wt. % sulfur compound.

2. The composition of claim 1, wherein the inorganic template has a framework density of about 10 to 25 and a wall thickness of less than about 30 angstroms.

3. The composition of claim 1, wherein the three-dimensional framework comprises rings having about 4 to 30 tetrahedrally coordinated atoms.

4. The composition of claim 1, wherein the rings have a dimension in a pore diameter of about 0.5 to 5 nanometers.

5. The composition of claim 1, wherein the inorganic template is siliceous or aluminosiliceous.

6. The composition of claim 1, wherein the composition comprises
about 2 to 8 wt. % polymeric binder,
about 70 to 90 wt. % carbon-sulfur composite, and
about 5 to 10 wt. % carbon black, and
wherein the carbon-sulfur composite comprises about 50 to 85 wt. % sulfur compound.

7. The composition of claim 1, wherein the carbon-sulfur composite is prepared utilizing a process for making comprising
introducing a carbon precursor into an inorganic template,
stabilizing carbon from the introduced carbon precursor to form a stabilized carbon in proximity with the inorganic template,
removing the inorganic template from the stabilized carbon to form a templated carbon, and
introducing a sulfur compound into the templated carbon to form the carbon-sulfur composite.

8. The composition of claim 1, wherein the inorganic template has a molecular crystallographic structure including at least one of AlO₄ and SiO₄.

9. A method for making a composition, comprising:
introducing a carbon precursor into an inorganic template;
stabilizing carbon from the introduced carbon precursor to form a stabilized carbon in proximity with the inorganic template;
removing the inorganic template from the stabilized carbon to form a templated carbon, the templated carbon having
a surface area of about 50 to 4,000 square meters per gram templated carbon, and
a pore volume of about 0.5 to 6 cubic centimeters per gram templated carbon, and
wherein the templated carbon has a carbon microstructure that is complementary with an inorganic microstructure, characterized by a three-dimensional framework, of an inorganic template used in a process for making the templated carbon; and
introducing an amount of sulfur compound into the templated carbon to form a carbon-sulfur composite comprising about 5 to 95 wt. % sulfur compound.

10. An electrode comprising:
A circuit contact; and
A composition comprising
about 1 to 17.5 wt. % polymeric binder, and
about 50 to 99 wt. % carbon-sulfur composite, the carbon-sulfur composite comprising templated carbon having
a surface area of about 50 to 4,000 square meters per gram templated carbon, and
a pore volume of about 0.5 to 6 cubic centimeters per gram templated carbon, and
wherein the templated carbon has a carbon microstructure that is complementary with an inorganic microstructure, characterized by a three-dimensional framework, of an inorganic template used in a process for making the templated carbon, and
about 5 to 95 wt. % sulfur compound.

11. The electrode of claim 10, wherein the inorganic template has a framework density of about 10 to 25.

12. The electrode of claim 10, wherein the three-dimensional framework comprises rings having about 4 to 30 tetrahedrally coordinated atoms.

13. The electrode of claim 10, wherein the inorganic template is siliceous or aluminosiliceous.

14. A method for using a cell, the method comprising at least one of
converting chemical energy stored in the cell into electrical energy; and
converting electrical energy into chemical energy stored in the cell, wherein the cell comprising
a negative electrode,
a positive electrode including a sulfur compound,
a circuit coupling the positive electrode and negative electrode, and
a lithium-containing electrolyte medium,
wherein the positive electrode incorporates a composition, the composition comprising
about 1 to 17.5 wt. % polymeric binder, and
about 50 to 99 wt. % carbon-sulfur composite, the carbon-sulfur composite comprising templated carbon having
a surface area of about 50 to 4,000 square meters per gram templated carbon, and
a pore volume of about 0.5 to 6 cubic centimeters per gram templated carbon,
wherein the templated carbon has a carbon microstructure that is complementary with an inorganic microstructure, characterized by a three-dimensional framework, of an inorganic template used in a process for making the templated carbon, and
about 5 to 95 wt. % sulfur compound.

15. The method of claim 14, wherein the cell is associated with at least one of a portable battery, a power source for an electrified vehicle, a power source for an ignition system of a vehicle and a power source for a mobile device.
